(19) United States
(12) Patent Application Publication
(10) Pub. No.: US 2003/0206999 A1
(43) Pub. Date: Nov. 6, 2003

(54) Dip it and lick it confection

(76) Inventors: Thomas J. Coleman, Abingdon, VA (US); William K. Schlotter IV, Fredericksburg, VA (US); Princess Ann Coleman, Abingdon, VA (US); Ann M. Schlotter, Fredericksburg, VA (US)

Correspondence Address: Clyde I. Coughenour, 16607 Sutton Place, Woodbridge, VA, 22191, US

(21) Appl. No.: 10/434,180

(22) Filed: May 9, 2003

Related U.S. Application Data
(63) Continuation-in-part of application No. 09/961,772, filed on Sep. 24, 2001.

(51) Int. Cl. A23B 4/00

(52) U.S. Cl. 426/115

(57) ABSTRACT

A main housing contains a fluid confection attached to a support for a solid confection. The fluid confection can be combined with the solid confection by dipping the solid confection into the fluid confection or by passing the fluid confection through a passage in the solid confection by tilting or pulling a vacuum on a tube in the main housing base. A secondary housing can be provided on the main housing for independently containing a second fluid confection that can be passed through the solid confection passage with the first fluid confection in the main housing transferred to the solid confection by dipping.

This is a continuation-in-part of Ser. No. 09/961,772 filed Sep. 24, 2001 having the title “Candy Dip It And Lick It” and now

### BACKGROUND OF THE INVENTION

1. Field of the Invention

A main housing contains a fluid confection attached to a support for a solid confection wherein the fluid confection can be applied to the surface of the solid confection.

2. Description of Related Art

The basic concept of mixing two different tastes together to produce a combination of tastes or a third taste is old. M. Stanger, U.S. Pat. No. 3,545,980, issued Dec. 8, 1970, teaches a solid consumable attached to one or both ends of a straw for use with a liquid. R. Marchewka et al, U.S. Pat. No. 4,091,632, issued May 30, 1978, teaches a beverage cooling device with a straw having a semi-flexible, spherical container around the straw for containing a liquid “foodstuff” that can be frozen, exposed and mixed with a beverage to flavor it. R. Knowlton, U.S. Pat. No. 2,226,474, issued Dec. 24, 1940, teaches a solid confection on one end of a stick that protrudes into a frozen confection for preferably alternate consumption. C. Claff, U.S. Pat. No. 2,121,185, issued Jun. 21, 1938, and A. Kreske, Jr., U.S. Pat. No. 4,229,482, issued Oct. 21, 1980, and “Desmettre,” French Publication 2,604,061 of Mar. 25, 1988, teach a solid confection on a stick with provision for internally dispensing a second fluid provided internally to mix the flavors of the two. C. Claff provides openings within the solid confection for dispensing the second fluid onto the surface of the solid confection and A. Kreske, Jr. and Desmettre provide the second fluid flavoring through a hollow passage. R. Russell, U.S. Pat. No. 3,821,425, issued Jun. 28, 1974, teaches a “solid on a stick” that is hollow for providing a liquid flavoring to coat any solid consumable held on the stick. T. Coleman, U.S. Pat. Nos. 5,324,527, issued Jun. 28, 1994, and Re 35,577, reissued Aug. 5, 1997, teaches a solid confection with a flow-through for fluid confection.

### SUMMARY OF THE INVENTION

Plural flavor confections are consumable simultaneously by securing a solid confection on a main housing containing a fluid confection (a liquid, gel or paste). The solid confection can be dipped into the fluid confection in the main housing or the fluid can be transported to the solid confection through passages in the solid confection by gravity or vacuum on a tube in a relatively rigid main housing. A secondary enclosure can be formed on the main housing to contain a third flavor confection in fluid form. An opening or hollow tube can be used between the solid confection and housing with a plug used to control fluid flow. The secondary enclosure can be removably secured to the main housing and the solid confection can be provided with a nipple and provided with a protective cover.

### BRIEF DESCRIPTION OF THE DRAWINGS

FIG. 1 is a side view of the candy holder illustrating a lollipop on a stick.

FIG. 2 is a side view of a modification in which a hard candy is molded into the end of a detachable end cap.

FIGS. 3 and 4 are side views of another modification with a secondary enclosure attached (FIG. 3) and removed (FIG. 4).

FIG. 5 is another side view of a further modification having a hollow tube for fluid transport.

FIG. 6 is another side view of a still further modification of a simplified embodiment.

FIGS. 7 and 8 are examples of different configurations of solid confections.

FIGS. 9 and 10 are side views for gravity and vacuum dispensing of fluid confections.

### DESCRIPTION OF THE PREFERRED EMBODIMENTS

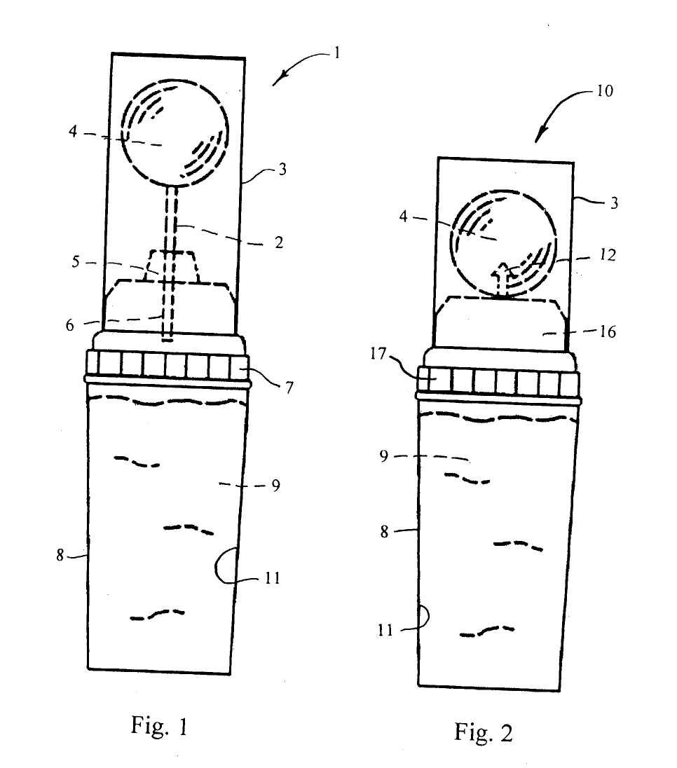

FIG. 1 is a side view of the confection device 1. The main housing 8 forms a reservoir 11 into which a liquid or gel or fluid confection 9 is stored. A detachable end cap 7 closes the upper open end of the housing. The end cap can be secured in a fluid tight manner by threads, friction or other means on the lower end of the end cap. The end cap is provided with a holder support 5 for a solid confection 4 on a stick 2. The holder support 5 includes an aperture 6 for securing the confection stick. The confection and upper end of the end cap 7 can be enclosed by a protective cover 3 secured to the top of the end cap.

FIG. 2 is a side view of a confection device 10 with a modified end cap 17 having a top section 16 provided with a nipple 12 for securing a solid confection 4 directly onto the detachable end cap by molding. As an additional feature the end cap and the nipple can be provided with the aperture 6 of FIG. 1 for reception of a confection stick after the consumption of the original solid confection 4.

The housing end and end cap are preferably formed by molding. The end cap may include an aperture 6. A liquid/gel/paste candy substance 9 is made and placed into the reservoir 11 of the housing 8. The end cap 7 is placed onto the housing 8. The end cap may include a lollipop 4 on a stick 2 with one end of the stick secured in the aperture or the end cap may be provided with a lollipop formed onto the end of the end cap 16. A protective cover 3 may be secured to the upper end 16 of the end cap to protect the candy. When one desires to consume a portion of the lollipop 4 and the liquid/gel/paste candy, the protective cover is removed, the end cap 16 is removed, and the lollipop can be dipped into the liquid/gel/paste candy substance 9. It would be obvious to one that the lollipop can be consumed without dipping the lollipop into the liquid/gel/paste candy substance or by dipping the lollipop into the liquid/gel/paste candy substance so that the lollipop in combination with the liquid/gel/paste candy can be consumed together. Once sufficient lollipop and/or lollipop and liquid/gel/paste candy substance has been consumed, the end cap may be placed back onto the housing and the protective cover may be replaced to protect the lollipop portion that remains. Obviously, the lollipop on the stick can be removed from the cap for consuming the candy combination and, after use, the stick with the remaining lollipop thereon can be replaced on the cap and the cap returned to the housing. The cap can be replaced onto the housing and then the lollipop on the stick can be replaced on the cap. The cover can then be replaced to protect the candy. The lollipop on the stick and also the liquid/gel/paste candy can be replenished when it has been consumed. In the modification shown in FIG. 2, the lollipop can be consumed and subsequent thereto a lollipop on a stick can be secured to the end cap for further pleasure.

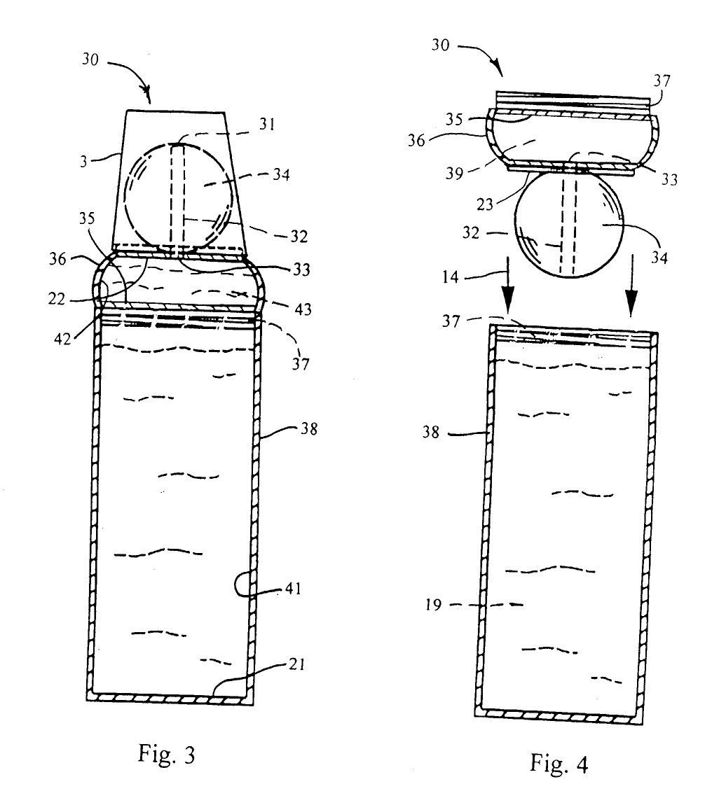

FIGS. 3 and 4 are side views of a modified embodiment 30 of the confection device. The solid confection 34 is provided with a passage 32 that extends to an opening 33 in a top end 22 of a secondary enclosure 36 reservoir 42 separated from the main housing 38 enclosure 41 by a barrier 35 of the secondary enclosure 36. The main housing 38 has an open top end and a bottom closed end 21. The reservoir 42 may be empty 39 or contain a liquid confection 43. The secondary enclosure is removably secured to the primary housing 38 by a threaded connection 37. The solid confection can be associated with a first fluid confection 43 that can flow through an opening 33 and solid confection passage 32 to outside the solid confection 34. A second fluid confection 19 can be supplied to the solid confection 34 by dipping 14 it into the main housing 38 through the upper opening at the threaded 37 area. A protective cover 3 is removably secured on the secondary enclosure 36 by fastening the cover over a friction cover securing provision 23.

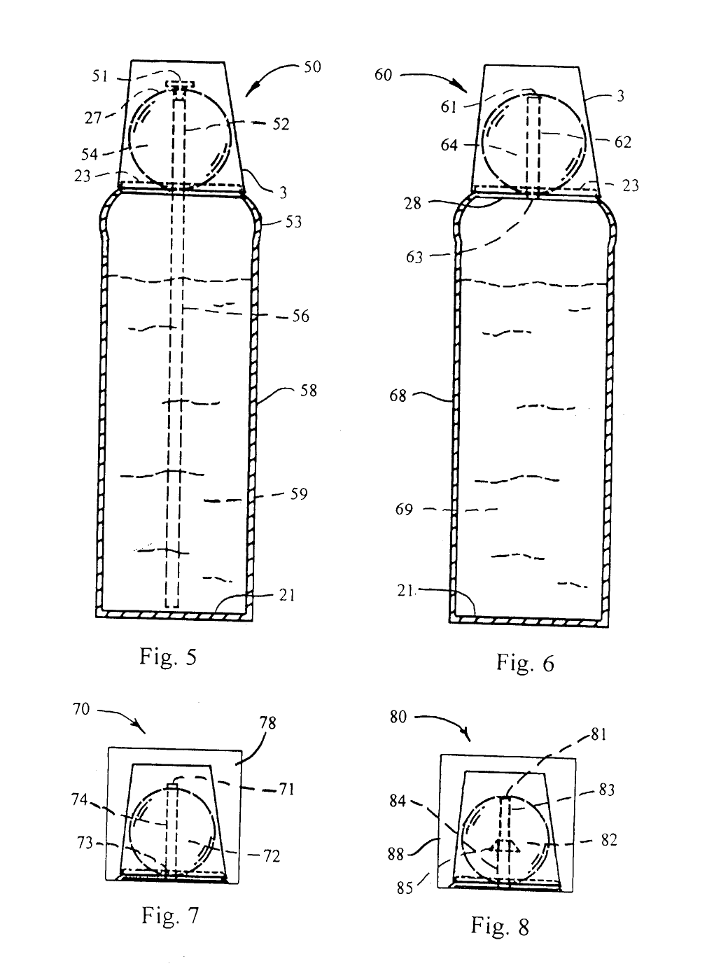

FIG. 5 is a side view of a further modified embodiment 50 of the confection device. The solid confection 54 has a passage 52 through it with the top or outer end having a removable plug 51 and mid and/or lower extent provided with a straw or hollow tube 56 that extends through the secondary enclosure 53 and into the main housing 58, essentially to its lower end 21. This embodiment permits the liquid/gel/paste 59 to be transferred onto the solid confection 54 by sucking or vacuum created on the upper end 27 of the solid confection after removal of the plug 51.

FIG. 6 is a side view of a further modified embodiment 60 of the confection device. The solid confection 64 is provided with a passage 62 that extends to an opening 63 in the upper extent or end 28 of the main housing 68. A plug 61 can be used to block fluid flow from inside the main housing 68 to outside the solid confection. The plug can be a thin film of solid confection extending over the upper end of the passage 62 that can be removed by licking or dissolving it as the solid confection is consumed. The fluid confection 69 is removed from the main housing 68 by tilting the confection device or by sucking on the solid confection in a tilted position.

FIGS. 7 and 8 show solid confection holding upper extensions 70, 80 for placement on secondary enclosures or main housings. The confection upper extensions 70,80 have covers 78,88. In FIG. 7 a plug 73 controls flow of fluid confections through a hollow tube 74 through the solid confection 72. The hollow tube extends beyond the solid confection 72 to form a nipple 71. In FIG. 8, the solid confection 82 is provided with a passage 83 blocked at its upper end with a plug 81 and has a larger passage at its lower end 84 than it has at its upper end 83 for reception of a hollow tube. The plug 81, as in FIG. 6, can be a film of solid confection formed over the upper end of the passage 83. A hollow nipple 85 is provided for securing the solid confection in place.

The nipple 71 is a part of or extension of the hollow tube 74 protruding beyond the upper surface of the solid confection 72. The plug 73 can be a part of the solid confections that can be penetrated by insertion of an implement through the tube 74. The plug 73 can alternately be a seating means closed or opened by an obstruction on the upper surface of a main or secondary housing the confection holder is placed over.

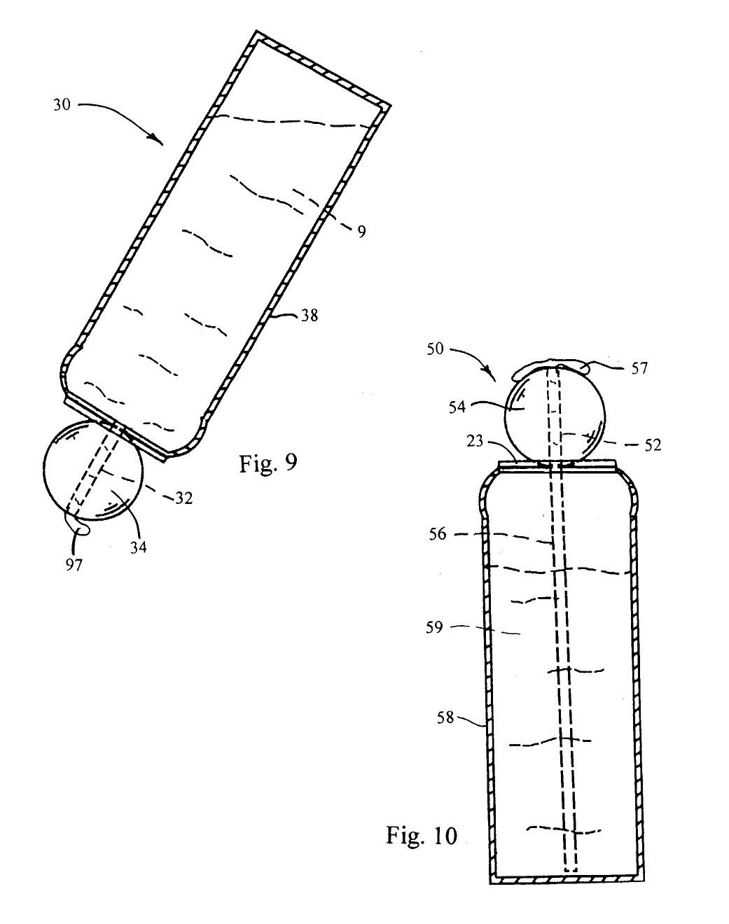

FIGS. 9 and 10 depict fluid confection being dispensed. FIG. 9 shows the confection device 30 of FIG. 3 tilted to dispense fluid confection 19 through the passage 32 onto the solid confection surface 97. FIG. 10 shows the confection device 50 of FIG. 5 with the plug removed and a vacuum or sucking on the top of the solid confection 54 used to draw fluid confection 59 through the tube 56 and passages 52 and onto the surface 57 of the solid confection 54.

It is believed that the construction, operation and advantages of this invention will be apparent to those skilled in the art. It is to be understood that the present disclosure is illustrative only and that changes, variations, substitutions, modifications and equivalents will be readily apparent to one skilled in the art and that such may be made without departing from the spirit of the invention as defined by the following claims.

1. A multi-confection device including:
a main housing for a fluid confection having an upper end and a lower end;
a closure means on said main housing upper end and a closure means on said main housing lower end for retaining said fluid confection in said main housing;
a solid confection secured to said main housing upper end closure means;
a passage through said solid confection having an upper opening and a lower opening;
an opening in said main housing upper end in communication with said passage lower opening through said solid confection;
a removable blocking means for controlling fluid confection flow through said passage through said solid confection.

2. A multi-confection device as in claim 1 including:
a hollow tube having an upper end and a lower end;
said hollow tube upper end being connected with said passage through said solid confection extending into said main housing for conducting said fluid confection through said solid confection.

3. A multi-confection device as in claim 2 wherein:
said hollow tube extends through said main housing with said lower end terminating adjacent to said main housing lower end.

4. A multi-confection device as in claim 1 including:
said main housing upper end having means for removably securing a protective cover;
a protective cover for enclosing said solid confection attached to said means for removably securing a protective cover.

5. A multi-confection device as in claim 1 including:
a secondary enclosure having an upper end and a lower end at said upper end of said main housing.

6. A multi-confection device as in claim 5 including:
a means for removably securing a protective cover on said secondary enclosure upper end;
a protective cover for enclosing said solid confection attached to said means for removably securing a protective cover.

7. A multi-confection device as in claim 1 wherein:
said solid confection upper end upper opening is provided with a plug formed by an extension of solid confection over said upper opening.

8. A multi-confection device as in claim 1 wherein:
said solid confection lower end lower opening is provided with said removable blocking means.

9. A multi-confection device as in claim 8 said solid confection upper end upper opening is provided with a nipple.

10. A multi-confection device as in claim 1 wherein:
said passage through said solid confection has a larger lower end than upper end to accommodate a hollow tube.

11. A multi-confection device including:
a main housing for a fluid confection having an upper end and a lower end;
a closure means on said main housing upper end and a closure means on said main housing lower end for retaining said fluid confection in said main housing;
a secondary enclosure having an upper end and a lower end at said upper end of said main housing;
a solid confection secured to said secondary enclosure upper end;
a passage through said solid confection;
an opening in said secondary enclosure upper end in communication with said passage through said solid confection.

12. A multi-confection device as in claim 111 including:
said secondary enclosure being removably secured to said main housing upper end so that said solid confection can be dipped into fluid confection within said main housing.

13. A multi-confection device as in claim 11 wherein:
a hollow tube extends from said passage through said solid confection into said secondary enclosure.

14. A multi-confection device as in claim 13 wherein:
said hollow tube extends through said secondary enclosure into said main housing.

15. A multi-confection device as in claim 14 wherein:
said hollow tube extends through said main housing with said lower end terminating adjacent to said main housing lower end.

16. A multi-confection device as in claim 111 including:
said main housing upper end having means for removably securing a protective cover;
a protective cover for enclosing said solid confection attached to said means for removably securing a protective cover.

17. A multi-confection device as in claim 11 including:
a blocking means for controlling fluid confection flow through said passage through said solid confection.

18. A multi-confection device as in claim 111 wherein:
said secondary enclosure is independent from said main housing with said lower end forming a barrier to fluid flow between said secondary enclosure and said main housing.

19. A multi-confection device as in claim 18 including:
said secondary enclosure being removably secured to said main housing upper end so that said solid confection can be dipped into fluid confection within said main housing.

20. A multi-confection device as in claim 17 wherein:
said blocking means is a thin plug formed on said outer end of said passage through said solid confection by an extension of said solid confection over said passage outer end.
